(19) United States
(12) Patent Application Publication
(10) Pub. No.: US 2014/0248547 A1
(43) Pub. Date: Sep. 4, 2014

(54) METHOD AND ARRANGEMENT FOR AVOIDING ANODE OXIDATION

(71) Applicants: Tero Hottinen, Lohja (FI); Kim Åström, Kirkkonummi (FI); Tuomas Hakala, Helsinki (FI)

(72) Inventors: Tero Hottinen, Lohja (FI); Kim Åström, Kirkkonummi (FI); Tuomas Hakala, Helsinki (FI)

(73) Assignee: Wartsila Finland Oy, Vaasa (FI)

(21) Appl. No.: 13/601,108

(22) Filed: Aug. 31, 2012

Related U.S. Application Data
(63) Continuation of application No. PCT/FI2011/050019, filed on Jan. 12, 2011.

(30) Foreign Application Priority Data
Mar. 1, 2010 (FI) 20105196

(51) Int. Cl. H01M 8/04

(52) U.S. Cl. CPC H01M 8/04231
USPC 429/429

(57) ABSTRACT

An arrangement for high temperature fuel cell system for substantially reducing the amount of purge gas in an emergency shut-down situation. The arrangement includes a known volume for containing a pneumatic actuation pressure, the known volume including at least one discharge route for designed discharge rate, at least one pressure source providing pressure capable of performing the pneumatic actuation, at least one purge gas source having a gas overpressure capable of displacing residual reactants in the fuel cell system. Purge gas is discharged through the discharge route causing pressure decline in the known volume, accomplishing a designed time delay in state change of at least one pneumatically actuated valve, to reduce or close down completely emergency shutdown actuated flow of the purge gas into the fuel cell system piping after the designed time delay.

### RELATED APPLICATIONS

This application claims priority as a continuation application under 35 U.S.C. §120 to PCT/FI2011/050019, which was filed as an International Application on Jan. 12, 2011 designating the U.S., and which claims priority to Finnish Application No. 20105196 filed in Finland on Mar. 1, 2010. The entire contents of these applications are hereby incorporated by reference in their entireties.

### FIELD

Disclosed is an arrangement suitable for use in a high temperature fuel cell system, for example, for reducing an amount of purge gas in an emergency shut-down situation.

### BACKGROUND INFORMATION

Energy can be produced by means of oil, coal, natural gas or nuclear power. These production methods can have concerns such as, for example, availability and friendliness to the environment. As far as the environment is concerned, for example, oil and coal can cause pollution when they are combusted. A concern associated with nuclear power is, at least, storage of used fuel.

In view of the environmental concerns, new energy sources have been developed which can be more environmentally friendly and, for example, can have a better efficiency than the above-mentioned energy sources. Fuel cell devices are promising future energy conversion devices in which fuel, for example bio gas, can be directly transformed to electricity via a chemical reaction in an environmentally friendly process.

As shown in FIG. 1, for example, a fuel cell can comprise an anode side 100 and a cathode side 102 and an electrolyte material 104 between them. In solid oxide fuel cells (SOFCs), oxygen 106 can be fed to the cathode side 102 and it can be reduced to a negative oxygen ion by receiving electrons from the cathode. The negative oxygen ion can go through the electrolyte material 104 to the anode side 100 where it can react with fuel 108 producing water and also carbon dioxide (CO₂). Between anode 100 and cathode 102 can be an external electric circuit 111 comprising a load 110 for the fuel cell.

FIG. 2, for example, shows a SOFC device as an example of a high temperature fuel cell device. A SOFC device can utilize as fuel, for example, natural gas, bio gas, methanol or other compounds containing hydrocarbon mixtures. A SOFC device as shown in FIG. 2 can comprise more than one, for example, a plurality of fuel cells in stack formation 103 (SOFC stack). Each fuel cell can comprise an anode 100 and cathode 102 structure as shown in FIG. 1. Part of the used fuel can be recirculated in feedback arrangement 109 through each anode. The SOFC device shown in FIG. 2 can also comprise a fuel heat exchanger 105 and a reformer 107. Heat exchangers can be used for controlling thermal conditions in the fuel cell process and more than one of them can be employed in different locations of the SOFC device. The extra thermal energy in circulating gas can be recovered in one or more heat exchanger 105 to be utilized in the SOFC device or outside the heat recovering unit. The reformer 107 is a device that can convert the fuel such as, for example, natural gas, to a composition suitable for fuel cells, for example, to a composition containing hydrogen and methane, carbon dioxide, carbon monoxide and inert gases. In each SOFC device, a reformer is optionally present.

For example, inert gases can be employed as purge gases or a part of purge gas compounds used in fuel cell technology. For example, nitrogen is an inert gas which can be used as a purge gas in fuel cell technology. Purge gases are not necessarily elemental and they can also be compound gases.

By using measurement means 115 (such as a fuel flow meter, current meter and temperature meter), desired measurements can be carried out for the operation of the SOFC device from the anode recirculating gas. For example, only part of the gas used at anodes 100 is recirculated through anodes in feedback arrangement 109 and the other part of the gas is exhausted 114 from the anodes 100.

A solid oxide fuel cell (SOFC) device is an electrochemical conversion device that can produce electricity directly from oxidizing a fuel. Exemplary advantages of SOFC device can include high efficiencies, long term stability, low emissions, and cost. An exemplary disadvantage can be the high operating temperature which can result in long start up times and both mechanical and chemical compatibility issues.

The anode electrode of solid oxide fuel cell (SOFC) can contain a significant amount of nickel that can be vulnerable to forming nickel oxide if the atmosphere is not reducing. If nickel oxide formation is severe, the morphology of electrode can be changed irreversibly causing significant loss of electrochemical activity or even break down of cells. Hence, SOFC systems can employ safety gas containing reductive agents (such as hydrogen diluted with an inert such as nitrogen) during the start-up and shut-down in order to mitigate or prevent the fuel cell's anode electrodes from oxidation. It can be desirable to minimize the amount of safety gas because an extensive amount of, for example, pressurized gas containing hydrogen can be expensive and problematic as space-utilizing components.

According to comparative applications, the amount of runtime reactants during normal start-up or shut-down can be minimized by anode recirculation, i.e., circulating the non-used safety gas back to the loop, as there can be simultaneous desire for minimization of the runtime reactants and heating in the start-up situation and also a simultaneous desire for minimization of the runtime reactants and cooling of the system in the shut-down situation. However, in emergency shut-down (ESD) which may be caused, for example, by gas alarm or black-out, there may not be active recirculation available, increasing the amount of desired safety gas. In addition, the cathode air flow may not be cooling the system during the ESD because of the shut down of the air blower. The amount of desired safety gas can be increased even more as the time to cool the system down to temperatures where nickel oxidation does not happen can be, for example, three-fold compared to an active shut-down situation.

### SUMMARY

According to an exemplary aspect, disclosed is an arrangement suitable for use in a high temperature fuel cell system, for reducing an amount of a purge gas in an emergency shut-down situation, wherein the system comprises a fuel cell including an anode side, a cathode side, and an electrolyte between the anode side and the cathode side, and a fuel cell system piping for reactants, wherein the arrangement is located in the cathode side of the high temperature fuel cell system for reducing the amount of purge gas in the cathode side in the emergency shut-down situation, the arrangement comprising: a known volume for containing a pneumatic actuation pressure, wherein the known volume comprises at least one discharge route, at least one pressure source providing pressure capable of performing the pneumatic actuation, at least one purge gas source containing as the purge gas nitrogen or nitrogen with an amount of oxygen, wherein the purge gas is directed to the cathode side of the fuel cell system to lessen or prevent oxygen from bleeding to the anode side of the fuel cell system from the cathode side of the fuel cell system to lessen or avoid anode side oxidation, where the purge gas source has a gas overpressure capable of displacing residual reactants in the fuel cell system, at least one valve for connecting the purge gas source to the fuel cell system piping, means for injecting a purge gas flow to the fuel cell system piping from the at least one purge gas source through said at least one valve, means for isolating the known volume from said at least one pressure source and for pressurizing the known volume, at least one pneumatically actuated valve utilizing pressure of the known volume for retaining a state, and means for closing at least one pipe outlet of the fuel cell system to lessen or prevent a gas flow from exiting the fuel cell system, wherein the known volume is pressurized in normal operation by the pressure source, and in an emergency shutdown the known volume is disconnected from the pressure source, purge gas is discharged through the discharge route causing pressure decline in the known volume, accomplishing a designed time delay in a state change of at least one pneumatically actuated valve, to reduce or close down completely an emergency shutdown actuated flow of purge gas into the fuel cell system piping after the designed time delay.

According to an exemplary aspect, disclosed is a method for reducing an amount of a purge gas in an emergency shut-down situation of a high temperature fuel cell system, wherein the method is performed in a cathode side of the high temperature fuel cell system for reducing the amount of purge gas in the cathode side in the emergency shut-down situation, the method comprising: utilizing a known volume for containing a pneumatic actuation pressure, wherein the known volume comprises at least one discharge route, applying pressure from at least one pressure source capable of performing the pneumatic actuation, displacing residual reactants in the fuel cell system by utilizing a gas overpressure in at least one purge gas source containing as the purge gas nitrogen or nitrogen with an amount of oxygen, wherein the purge gas is directed to the cathode side of the fuel cell system to lessen or prevent oxygen from bleeding to the anode side of the fuel cell system from the cathode side of the fuel cell system to lessen or avoid anode side oxidation, connecting the purge gas source to the fuel cell system piping by at least one valve, injecting a purge gas flow to the fuel cell system piping from the at least one purge gas source through said at least one valve, isolating the known volume from said at least one pressure source and pressurizing the known volume, using at least one pneumatically actuated valve for utilizing pressure of the known volume for retaining a state, closing at least one pipe outlet of the fuel cell system to lessen or prevent a gas flow from exiting the fuel cell system, wherein the known volume is pressurized in normal operation, and in an emergency shutdown said known volume is disconnected from the pressure source, purge gas is discharged through the discharge route causing pressure decline in the known volume, accomplishing a designed time delay in state change of at least one pneumatically actuated valve, to reduce or close down completely emergency shutdown actuated flow of purge gas into the fuel cell system piping after the designed time delay.

According to an exemplary aspect, disclosed is a high temperature fuel cell system, comprising: a fuel cell including an anode side, a cathode side, and an electrolyte between the anode side and the cathode side, a fuel cell system piping, an arrangement for reducing an amount of a purge gas in an emergency shut-down situation, wherein the arrangement is located in the cathode side of the fuel cell, the arrangement comprising: a known volume for containing a pneumatic actuation pressure, wherein the known volume comprises at least one discharge route, at least one pressure source providing pressure capable of performing the pneumatic actuation, at least one purge gas source containing as the purge gas nitrogen or nitrogen with an amount of oxygen, wherein the purge gas is directed to the cathode side of the fuel cell system to lessen or prevent oxygen from bleeding to the anode side of the fuel cell system from the cathode side of the fuel cell system to lessen or avoid anode side oxidation, where the purge gas source has a gas overpressure capable of displacing residual reactants in the fuel cell system, at least one valve for connecting the purge gas source to the fuel cell system piping, a device for injecting a purge gas flow to the fuel cell system piping from the at least one purge gas source through said at least one valve, a device for isolating the known volume from said at least one pressure source and for pressurizing the known volume, at least one pneumatically actuated valve utilizing pressure of the known volume for retaining a state, and a device for closing at least one pipe outlet of the fuel cell system to lessen or prevent a gas flow from exiting the fuel cell system, wherein the known volume is pressurized in normal operation by the pressure source, and in an emergency shutdown the known volume is disconnected from the pressure source, purge gas is discharged through the discharge route causing pressure decline in the known volume, accomplishing a designed time delay in a state change of at least one pneumatically actuated valve, to reduce or close down completely an emergency shutdown actuated flow of purge gas into the fuel cell system piping after the designed time delay.

According to an exemplary aspect, disclosed is a fuel cell system where the risk of anode oxidation in shut-down situations can be significantly reduced. This can be achieved, for example, by an arrangement for a high temperature fuel cell system for substantially reducing the amount of purge gas in an emergency shut-down situation. Each fuel cell in the fuel cell system can comprise an anode side, a cathode side, and an electrolyte between the anode side and the cathode side. The fuel cell system can comprise a fuel cell system piping for reactants. The arrangement can comprise a known volume for containing a pneumatic actuation pressure, said known volume comprising at least one discharge route for designed discharge rate, at least one pressure source providing pressure capable of performing the pneumatic actuation, at least one purge gas source having a gas overpressure capable of displacing residual reactants in the fuel cell system, at least one valve for connecting the purge gas source to the fuel cell system piping, means for injecting a purge gas flow to the fuel cell system piping from the at least one purge gas source, means for isolating the known volume from said at least one pressure source and for pressurizing the known volume, at least one pneumatically actuated valve utilizing pressure of the known volume for retaining a state, and said known volume being pressurized in normal operation by the pressure source, and in emergency shutdown being disconnected from the pressure source, purge gas discharge through the discharge route causing pressure decline in the known volume, accomplishing a designed time delay in state change of at least one pneumatically actuated valve, to reduce or close down completely an emergency shutdown actuated flow of purge gas into the fuel cell system piping after the designed time delay.

In accordance with an exemplary aspect, disclosed is a method for substantially reducing the amount of purge gas in an emergency shut-down situation of a high temperature fuel cell system. The method can include utilizing a known volume for containing a pneumatic actuation pressure, arranging pressure from at least one pressure source capable of performing the pneumatic actuation, displacing residual reactants in the fuel cell system by utilizing a gas overpressure in at least one purge gas source, connecting the purge gas source to the fuel cell system piping by at least one valve, injecting a purge gas flow to a fuel cell system piping from the at least one purge gas source, isolating the known volume from said at least one pressure source and pressurized the known volume, using at least one pneumatically actuated valve for utilizing pressure of the known volume for retaining a state. In the method, the known volume can be pressurized in normal operation, and in emergency shutdown said known volume can be disconnected from the pressure source, purge gas discharge through the discharge route causing pressure decline in the known volume, accomplishing a designed time delay in state change of at least one pneumatically actuated valve, to reduce or close down completely an emergency shutdown actuated flow of purge gas into the fuel cell system piping after the designed time delay.

An exemplary aspect is based on the utilization of pressure capable of performing the pneumatic actuation and of gas overpressure capable of displacing residual reactants in the fuel cell system and on the utilization of a known volume for containing pneumatic actuation pressure, and which known volume comprises at least one discharge route for a designed discharge rate. An exemplary aspect is further based on at least one pneumatically actuated valve utilizing pressure of the known volume for retaining a state, and said known volume being pressurized in normal operation by a pressure source providing said pressure capable of performing the pneumatic actuation, and in emergency shutdown being disconnected from the pressure source, purge gas discharge through the discharge route causing pressure decline in the known volume, causing a designed delay in state change of at least one pneumatically actuated valve, to reduce emergency shutdown actuated flow of purge gas into the fuel cell system piping after the designed delay.

An exemplary advantage is that the risk of anode oxidation in emergency shut-down situations, for example, can be significantly avoided, and thus lifetime of the fuel cell system can be increased.

### BRIEF DESCRIPTION OF THE DRAWINGS

FIG. 1 is a diagram of a single fuel cell, in accordance with an exemplary aspect.

FIG. 2 is a diagram of a SOFC device, in accordance with an exemplary aspect.

FIG. 3 is a diagram of an arrangement suitable for use in a high temperature fuel cell system, for reducing an amount of purge gas in an emergency shut-down situation, in accordance with an exemplary aspect.

FIG. 4 is a diagram of an arrangement suitable for use in a high temperature fuel cell system, for reducing an amount of purge gas in an emergency shut-down situation, in accordance with an exemplary aspect.

### DETAILED DESCRIPTION

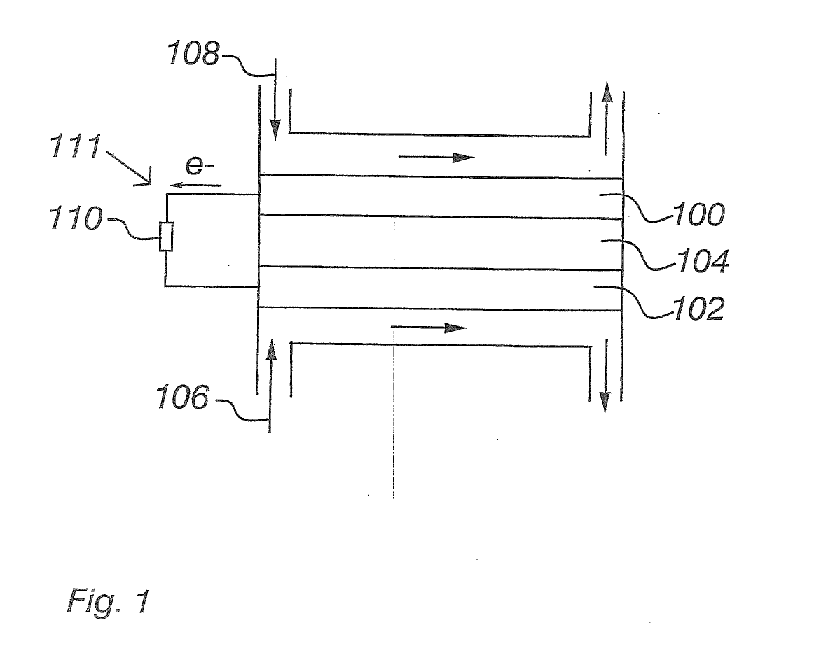

In an exemplary embodiment, solid oxide fuel cells (SOFCs) can have any suitable geometry. A planar geometry (for example, as shown in FIG. 1) is a sandwich-type geometry and can be employed in many types of fuel cells. The electrolyte 104 can be sandwiched in between the electrodes, anode 100 and cathode 102. SOFCs can also be made in tubular geometries where, for example, either air or fuel is passed through the inside of the tube and the other gas is passed along the outside of the tube. This can be arranged so that the gas used as fuel is passed through the inside of the tube and air is passed along the outside of the tube. The tubular design can be better in sealing air from the fuel. The performance of the planar design can be better than the performance of the tubular design because the planar design can have a lower resistance by comparison. Other geometries of SOFCs can include modified planar cells (MPC or MPSOFC), where a wave-like structure can replace the traditional flat configuration of the planar cell. Such designs can be promising because they can share the exemplary advantages of both planar cells (low resistance) and tubular cells.

For example, ceramics used in SOFCs do not become ionically active until they reach very high temperature. As a consequence, for example, the stacks can be heated at temperatures ranging from 600 to 1,000° C. Reduction of oxygen 106 (FIG. 1) into oxygen ions can occur at the cathode 102. These ions can then be transferred through the solid oxide electrolyte 104 to the anode 100 where they can electrochemically oxidize the gas used as fuel 108. In this reaction, water and carbon dioxide byproducts can be given off as well as two electrons. These electrons can then flow through an external circuit 111 where they can be utilized. The cycle can then repeat as those electrons enter the cathode material 102 again.

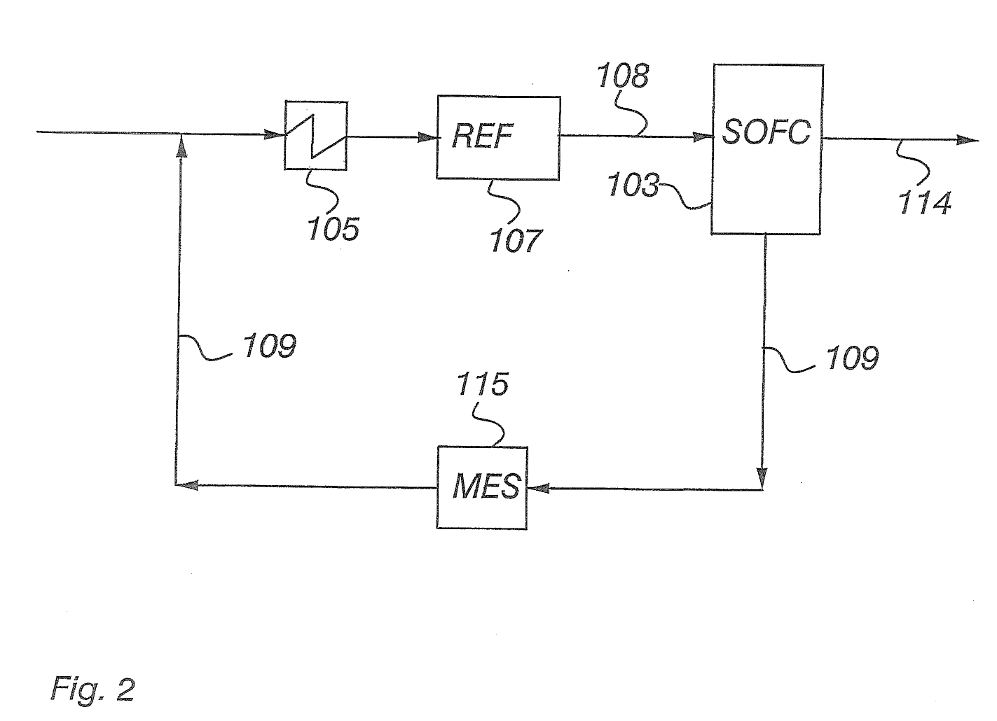

In large solid oxide fuel cell systems, fuels can be natural gas (for example, mainly methane), different biogases (for example, mainly nitrogen and/or carbon dioxide diluted methane), and other higher hydrocarbon containing fuels such as, for example, alcohols. It can be desirable to reform methane and higher hydrocarbons either in the reformer 107 (FIG. 2) before entering the fuel cell stacks 103 or (partially) internally within the stacks 103. The reforming reactions can employ a certain amount of water, and additional water can also be employed to prevent possible carbon formation (coking) caused by higher hydrocarbons. This water can be provided internally by circulating the anode gas exhaust flow, because water is produced in excess amounts in fuel cell reactions, and/or said water can be provided with an auxiliary water feed (for example, direct fresh water feed or circulation of exhaust condensate). For example, by anode recirculation arrangement, part of the unused fuel and dilutants in anode gas can be fed back to the process, whereas in auxiliary water feed arrangement, for example, the only additive to the process is water.

In an exemplary embodiment, means to feed inert gas as purge gas (for example, safety gas) to the cathode can be provided. The inert gas (for example, nitrogen) may also contain a little amount of oxygen. Said inert gas can be fed passively to the cathode, and by blocking the cathode in case of ESD (Emergency Shut-Down), there is, for example, no oxygen penetrating to the anode, and hence the risk of anode oxidation can be significantly reduced. The flushing of the piping on the anode side can be accomplished with a small amount of purge gas, and on the cathode side also with a small amount of purge gas, which can be inert gas on the cathode side. If the blocking valves are of a normally-closed type, and are not too rapidly closed (for example, slow spring loaded valves), then runtime reactants (for example, air) in cathode pipes can be removed by flushing. For example, no additional air is penetrated into the cathode part of the system after blocking, enabling the use. For example, the amount of purge gas employed during the ESD can be significantly reduced. For example, similar types of blocking valves can also be used in the anode side to decrease the amount of purge gas used even further.

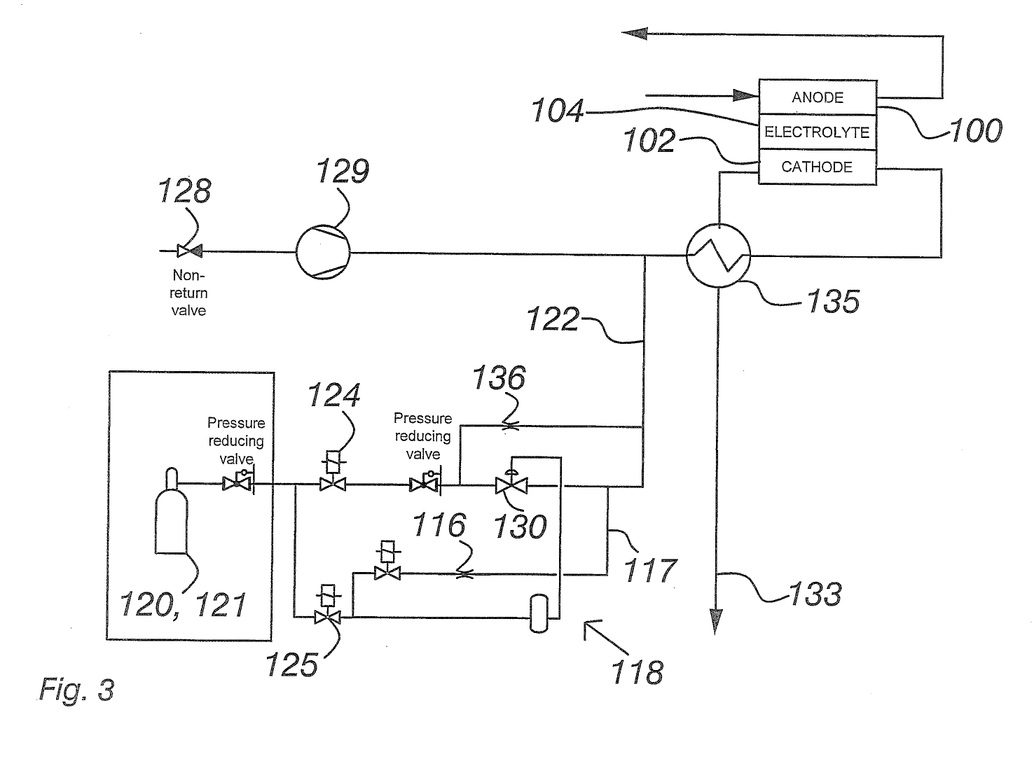

FIG. 3 shows an exemplary arrangement suitable for use in a high temperature fuel cell system. The arrangement can be located in the cathode side 102 of a high temperature fuel cell system for substantially reducing the amount of purge gas in the cathode side in the case of an emergency shut-down situation. For example, the arrangement can also be applied in the anode side 100 or simultaneously both in the anode side 100 and the cathode side 102 of the high temperature fuel cell system.

The arrangement can comprise a known volume 118 for containing a pneumatic actuation pressure, said known volume comprising piping of the fuel cell system and at least one discharge route 117 for designed discharge rate. At least one pressure source 120 can provide pressure capable of performing the pneumatic actuation.

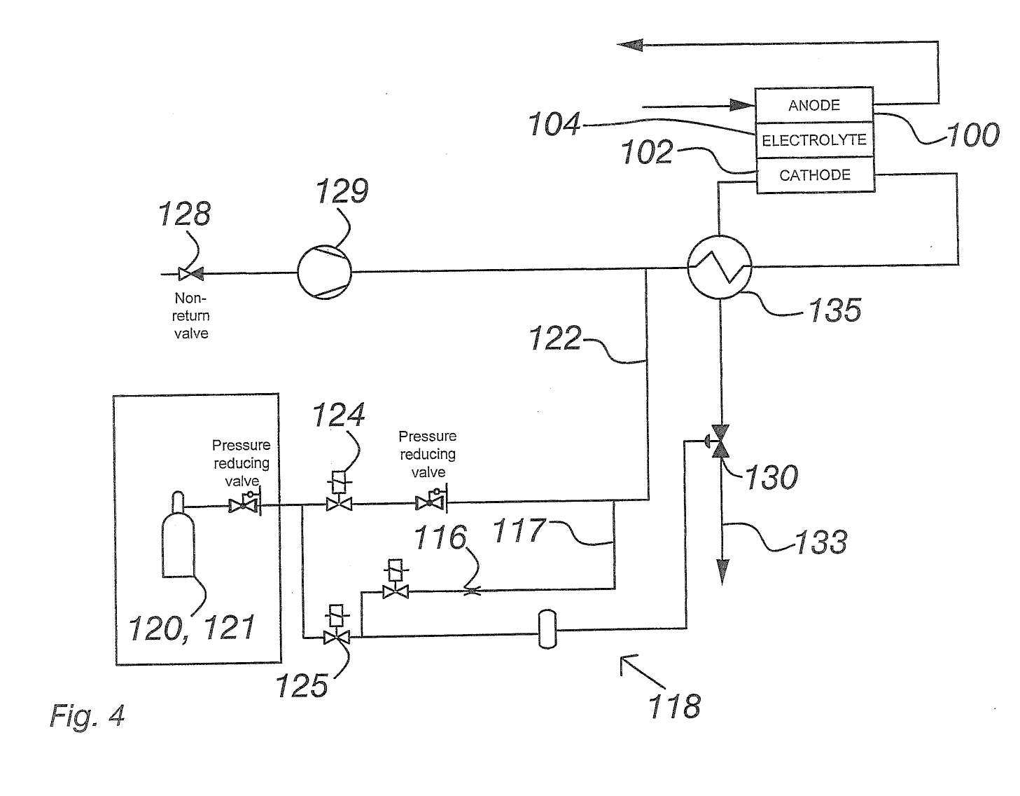

The arrangement can comprise at least one purge gas source 121 having a gas overpressure capable of displacing residual reactants in the fuel cell system. For example, the purge gas source 121 can have an exemplary gas overpressure compared to pressure in the surroundings of said purge gas source. At least one valve 124 in the arrangement can connect the purge gas source 121 to the fuel cell system piping, and means 122 can inject a purge gas flow to the fuel cell system piping from the at least one purge gas source 121. Means 122 can include, for example, pipe, channel, duct, bore and/or hole. Means 128 can shut at least one pipe ending of the fuel cell system to prevent the gas flow from exiting the fuel cell system. Means 128 can include, for example, any valve which closes when actuating pressure is relieved, utilizing in closing action energy stored in, for example, a spring, a pressure accumulator or gravitational potential. Also the arrangement can comprise means 125 for isolating the known volume from said at least one pressure source 120 and said means 125 for pressurizing the known volume 118. Means 125 can include, for example, any valve which closes when de-energized in the event of emergency shut-down, utilizing in closing action energy stored, for example, in a spring, a pressure accumulator or gravitational potential. At least one pneumatically actuated valve 130 can utilize pressure of the known volume 118 for retaining a state. The arrangement may also comprise at least one air blower 129 and at least one orifice 136. In FIG. 3, in the bypass route over the pneumatically actuated valve 130, the orifice 136 can be designed to restrict the amount of bypassing purge gas flow. For example, the bypassing flow is only a fraction of the flow through the valve 130 when it is open. After closing of the valve 130, the passage through the orifice 136 can ensure that a small flow through the fuel cell cathode to the piping 133 is maintained, and the risk of oxygen flowing in reverse direction from piping 133 into the arrangement can be reduced. Orifice 116, in FIGS. 3 and 4, can be a flow restriction in the piping of the discharge route 117. It can be dimensioned to restrict the purge gas flow in order to achieve the designed time delay in state change of the pneumatically actuated valve 130.

During normal operation, the known volume 118 can be pressurized by the pressure source 120. In an emergency shutdown situation, the known volume can be disconnected from the pressure source 120, and purge gas discharge through the discharge route 117 of the known volume can cause pressure decline in the known volume 118. This can accomplish a designed time delay in state change of at least one pneumatically actuated valve 130, to reduce or close down completely emergency shutdown actuated flow of purge gas into the fuel cell system piping after the designed time delay. The designed time delay can be sized, for example, to correspond to the total volumetric flow of purge gas, for example, that equals at least 6 times the volume of the system piping ensuring adequate displacing of residual reactants, the sizing being not restricted to this. The duration of said designed time delay can be, for example, from 10 seconds to one hour.

FIG. 4 shows a second exemplary arrangement suitable for use in a high temperature fuel cell system. The arrangement can be located in the cathode side 102 of high temperature fuel cell system for substantially reducing the amount of purge gas in the cathode side in the case of an emergency shut-down situation. The arrangement can also be applied in the anode side 100 or simultaneously both in the anode side 100 and the cathode side 102 of the high temperature fuel cell system. The arrangement can comprise as the pneumatically actuated valve 130 at least one controllable regulating device 130 to be pneumatically actuated for substantially limiting or closing down completely the purge gas flow after said designed time delay. The location of said controllable regulating device 130 can be in the output piping 133 of an air recuperator 135, as shown in FIG. 4. An exemplary embodiment shown in FIG. 4 can comprise similar features as presented in the exemplary embodiment shown in FIG. 3.

In an exemplary embodiment, a pressure unit 120, 121 can be utilized for performing the functions of both said pressure source 120 and said purge gas source 121.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. An arrangement suitable for use in a high temperature fuel cell system, for reducing an amount of a purge gas in an emergency shut-down situation, wherein the system comprises a fuel cell including an anode side, a cathode side, and an electrolyte between the anode side and the cathode side, and a fuel cell system piping for reactants, wherein the arrangement is located in the cathode side of the high temperature fuel cell system for reducing the amount of purge gas in the cathode side in the emergency shut-down situation, the arrangement comprising:
a known volume for containing a pneumatic actuation pressure, wherein the known volume comprises at least one discharge route,
at least one pressure source providing pressure capable of performing the pneumatic actuation,
at least one purge gas source containing as the purge gas nitrogen or nitrogen with an amount of oxygen, wherein the purge gas is directed to the cathode side of the fuel cell system to lessen or prevent oxygen from bleeding to the anode side of the fuel cell system from the cathode side of the fuel cell system to lessen or avoid anode side oxidation, where the purge gas source has a gas overpressure capable of displacing residual reactants in the fuel cell system,
at least one valve for connecting the purge gas source to the fuel cell system piping,
means for injecting a purge gas flow to the fuel cell system piping from the at least one purge gas source through said at least one valve,
means for isolating the known volume from said at least one pressure source and for pressurizing the known volume,
at least one pneumatically actuated valve utilizing pressure of the known volume for retaining a state of the at least one pneumatically actuated valve, and
means for closing at least one pipe outlet of the fuel cell system to lessen or prevent a gas flow from exiting the fuel cell system,
wherein the known volume is pressurized in normal operation by the pressure source, and in an emergency shutdown the known volume is disconnected from the pressure source, purge gas is discharged through the discharge route causing pressure decline in the known volume, accomplishing a designed time delay in a state change of at least one pneumatically actuated valve, to reduce or close down completely an emergency shutdown actuated flow of purge gas into the fuel cell system piping after the designed time delay.

2. The arrangement according to claim 1, wherein the at least one purge gas source has a gas overpressure compared to a pressure in surroundings of the at least one purge gas source.

3. The arrangement according to claim 1, wherein the pressure source and the purge gas source are comprised in a single pressure unit.

4. The arrangement according to claim 1, wherein the pneumatically actuated valve includes at least one controllable regulating device to be pneumatically actuated for limiting or closing down completely the purge gas flow after said designed time delay.

5. A method for reducing an amount of a purge gas in an emergency shut-down situation of a high temperature fuel cell system, wherein the method is performed in a cathode side of the high temperature fuel cell system for reducing the amount of purge gas in the cathode side in the emergency shut-down situation, the method comprising:
utilizing a known volume for containing a pneumatic actuation pressure, wherein the known volume comprises at least one discharge route,
applying pressure from at least one pressure source capable of performing the pneumatic actuation,
displacing residual reactants in the fuel cell system by utilizing a gas overpressure in at least one purge gas source containing as the purge gas nitrogen or nitrogen with an amount of oxygen, wherein the purge gas is directed to the cathode side of the fuel cell system to lessen or prevent oxygen from bleeding to the anode side of the fuel cell system from the cathode side of the fuel cell system to lessen or avoid anode side oxidation,
connecting the purge gas source to the fuel cell system piping by at least one valve,
injecting a purge gas flow to the fuel cell system piping from the at least one purge gas source through said at least one valve,
isolating the known volume from said at least one pressure source and pressurizing the known volume,
using at least one pneumatically actuated valve for utilizing pressure of the known volume for retaining a state of the at least one pneumatically actuated valve,
closing at least one pipe outlet of the fuel cell system to lessen or prevent a gas flow from exiting the fuel cell system,
wherein the known volume is pressurized in normal operation, and in an emergency shutdown said known volume is disconnected from the pressure source, purge gas is discharged through the discharge route causing pressure decline in the known volume, accomplishing a designed time delay in a state change of at least one pneumatically actuated valve, to reduce or close down completely emergency shutdown actuated flow of purge gas into the fuel cell system piping after the designed time delay.

6. The method according to claim 5, wherein the purge gas source has a gas overpressure compared to pressure in surroundings of the purge gas source.

7. The method according to claim 6, wherein a single pressure unit is utilized for performing functions of the pressure source and the purge gas source.

8. The method according to claim 6, wherein the pneumatically actuated valve includes at least one controllable regulating device to be pneumatically actuated for limiting or closing down completely the purge gas flow after said designed time delay.

9. The method according to claim 5, wherein the duration of said designed time delay is from 10 seconds to one hour.

10. The arrangement according to claim 1, wherein the means for injecting a purge gas flow include a pipe, a channel, a duct, a bore, a hole or a combination thereof.

11. The arrangement according to claim 1, wherein the means for isolating the known volume from said at least one pressure source and for pressurizing the known volume include a valve which closes when de-energized in an event of an emergency shut-down.

12. The arrangement according to claim 1, wherein the means for closing at least one pipe outlet include a valve which closes when actuating pressure is relieved.

13. The arrangement according to claim 1, wherein the arrangement is arranged such that the duration of said designed time delay is from 10 seconds to one hour.

14. A high temperature fuel cell system, comprising:
a fuel cell including an anode side, a cathode side, and an electrolyte between the anode side and the cathode side,
a fuel cell system piping,
an arrangement for reducing an amount of a purge gas in an emergency shut-down situation, wherein the arrangement is located in the cathode side of the fuel cell, the arrangement comprising:
a known volume for containing a pneumatic actuation pressure, wherein the known volume comprises at least one discharge route,
at least one pressure source providing pressure capable of performing the pneumatic actuation,
at least one purge gas source containing as the purge gas nitrogen or nitrogen with an amount of oxygen, wherein the purge gas is directed to the cathode side of the fuel cell system to lessen or prevent oxygen from bleeding to the anode side of the fuel cell system from the cathode side of the fuel cell system to lessen or avoid anode side oxidation, where the purge gas source has a gas overpressure capable of displacing residual reactants in the fuel cell system,
at least one valve for connecting the purge gas source to the fuel cell system piping,
a device for injecting a purge gas flow to the fuel cell system piping from the at least one purge gas source through said at least one valve,
a device for isolating the known volume from said at least one pressure source and for pressurizing the known volume,
at least one pneumatically actuated valve utilizing pressure of the known volume for retaining a state of the at least one pneumatically actuated valve, and
a device for closing at least one pipe outlet of the fuel cell system to lessen or prevent a gas flow from exiting the fuel cell system,
wherein the known volume is pressurized in normal operation by the pressure source, and in an emergency shutdown the known volume is disconnected from the pressure source, purge gas is discharged through the discharge route causing pressure decline in the known volume, accomplishing a designed time delay in a state change of at least one pneumatically actuated valve, to reduce or close down completely an emergency shutdown actuated flow of purge gas into the fuel cell system piping after the designed time delay.

15. The system according to claim 14, wherein the at least one purge gas source has a gas overpressure compared to a pressure outside of the at least one purge gas source.

16. The system according to claim 14, wherein the pressure source and the purge gas source are comprised in a single pressure unit.

17. The system according to claim 14, wherein the pneumatically actuated valve includes at least one controllable regulating device to be pneumatically actuated for limiting or closing down completely the purge gas flow after said designed time delay.

18. The system according to claim 14, wherein the device for injecting a purge gas flow include a pipe, a channel, a duct, a bore, a hole or a combination thereof.

19. The system according to claim 14, wherein the device for isolating the known volume from said at least one pressure source and for pressurizing the known volume include a valve which closes when de-energized in an event of an emergency shut-down.

20. The system according to claim 14, wherein the device for closing at least one pipe outlet include a valve which closes when actuating pressure is relieved.
